(19) United States
(12) Patent Application Publication
(10) Pub. No.: US 2013/0198513 A1
(43) Pub. Date: Aug. 1, 2013

(54) ENCRYPTION METHOD AND SYSTEM FOR NETWORK COMMUNICATION

(71) Applicant: Brian KIM, Redwood City, CA (US)

(72) Inventor: Brian KIM, Redwood City, CA (US)

(73) Assignee: DoctorCom, Inc.

(21) Appl. No.: 13/360,573

(22) Filed: Jan. 27, 2012

(51) Int. Cl. H04L 9/32

(52) U.S. Cl. 713/168

(57) ABSTRACT

Provided are devices and methods for data encryption and securely transmitting data over a network. The methods can include receiving a request to retrieve a message encrypted with an object key, which is encrypted with a public key from a public/private key pair associated with the recipient, decrypting the encrypted message by decrypting the object key with the private key, and delivering or displaying the message to the recipient.

### FIELD OF THE DISCLOSURE

Provided embodiments of the present disclosure generally relate to devices and methods for data encryption and securely transmitting data over a network.

### BACKGROUND

While network communication becomes ever more prevalent in our daily life, the importance of data security has also increased. Some typical forms of network communication include email communication, instant messaging, text messaging and voice messaging. Such communication sometime involves personal data, such as personal identification, financial data and medical record, and protection of such data from inadvertent or even intentional security breach is critical to the communication.

### SUMMARY OF THE DISCLOSURE

The disclosure, in some embodiments, provides methods for secure data transmission. Computing devices and program code embedded in non-transitory computer-readable media are also provided.

In one embodiment, the present disclosure provides a method for securely transmitting a message to a recipient, comprising receiving, at a server, a request from a recipient to retrieve a message, wherein the message is encrypted with an object key; wherein the object key is encrypted with a public key from a public/private key pair associated with the recipient, and the private key is encrypted based on a user key associated with the recipient's login credential, the public/private key pair being configured so that information encrypted with the public key can only be decrypted with the private key; and wherein the request is accompanied by a secure string, the secure string being generated by combining a random string and the user key, wherein the user key is retrieved when the recipient logs in; decrypting the encrypted message by: reconstituting the user key with the secure string and the random string; decrypting the private key of the recipient with the user key; and decrypting the object key with the private key; and decrypting the message with the object key. The method can further comprise delivering or displaying the message to the recipient.

In one aspect, the private key is encrypted with a protection key, which is encrypted with the user key. Accordingly, in one aspect, the decrypting of the private key comprises decrypting the protection key with the user key and decrypting the private key with the protection key.

In certain aspects, the server does not store, in a non-volatile memory, any one of non-encrypted message, non-encrypted object key, non-encrypted private key, non-encrypted user key, or the secure string. In some aspects, only the public key and/or the random string are stored on the server without encryption. In yet some aspects, the secure string is stored on the user's system, not on the server. One advantage of such a design is that there is no security threat unless both the server and user systems are compromised.

In one aspect, the login credential of the recipient comprises the password of the recipient. In another aspect, the system does not store the password. Instead, the password can be verified with a hash function.

In some aspects, the public/private key pair is an RSA public/private key pair.

In some aspects, the user key is retrievable with a hash function with the recipient's credential.

In one aspect, the random string has the same string length as the user key. In another aspect, the secure string is generated with an XOR cipher using the random string and the user key as inputs.

Without limitation, messages that can be suitably encrypted by the disclosed methods can be an email message, a text message, an instant message, an voice message, a video message, a news message or an electronic document. A send or retrieval request can be sent, for instance, from any computing device such as a mobile device.

### BRIEF DESCRIPTION OF THE DRAWINGS

Provided embodiments are illustrated by way of example, and not limitation, in the figures of the accompanying drawings in which:

FIG. 1 illustrates a process for encrypting a message (data);

FIG. 2A-B shows two exemplary processes for encrypting a private key (pri), using a user key (usr) directly, or using a protection key (prot) that can be encrypted by the user key (usr);

FIG. 3 shows one embodiment of setting up the decryption process when the recipient of a message logs into the system to retrieve the message that requires decryption; and

FIG. 4 shows an exemplary process of decrypting a message.

It will be recognized that some or all of the figures are schematic representations for purposes of illustration and do not necessarily depict the actual relative sizes or locations of the elements shown. The figures are provided for the purpose of illustrating one or more embodiments with the explicit understanding that they will not be used to limit the scope or the meaning of the claims.

### DETAILED DESCRIPTION OF THE DISCLOSURE

As used herein, certain terms have the following defined meanings Terms that are not defined have their art recognized meanings.

As used in the specification and claims, the singular form “a”, “an” and “the” include plural references unless the context clearly dictates otherwise.

As used herein, the term “comprising” is intended to mean that the compositions and methods include the recited elements, but not excluding others. “Consisting essentially of” when used to define compositions and methods, shall mean excluding other elements that would materially affect the basic and novel characteristics of the technology. “Consisting of” shall mean excluding any element, step, or ingredient not specified in the claim. Embodiments defined by each of these transition terms are within the scope of this disclosure.

A “processor” is an electronic circuit that can execute computer programs. Examples of processors include, but are not limited to, central processing units, microprocessors, graphics processing units, physics processing units, digital signal processors, network processors, front end processors, coprocessors, data processors and audio processors.

A “memory” refers to an electrical device that stores data for retrieval. In one aspect, a memory is a computer unit that preserves data and assists computation.

The terms “message”, “data”, and “information” are used interchangeably throughout the disclosure to refer to any electronic information which can be stored in a computer media or transmitted over a network. Non-limiting examples include email messages, text messages, instant messages, voice messages, video messages, news messages and any electronic documents.

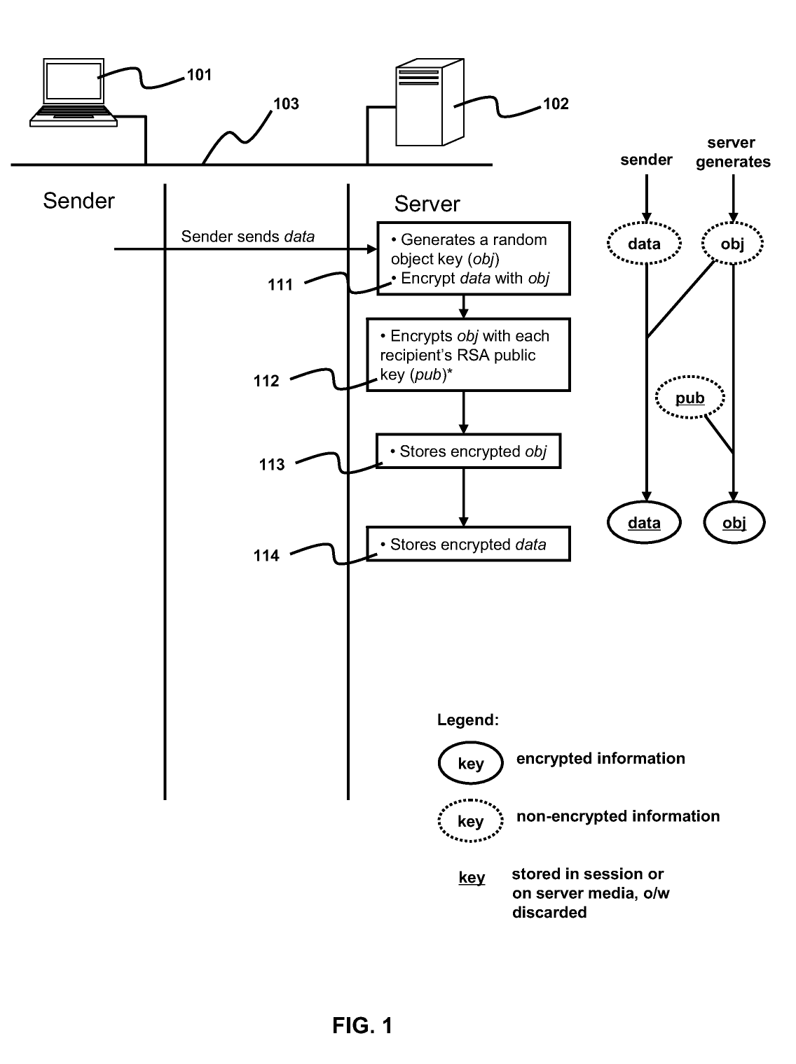

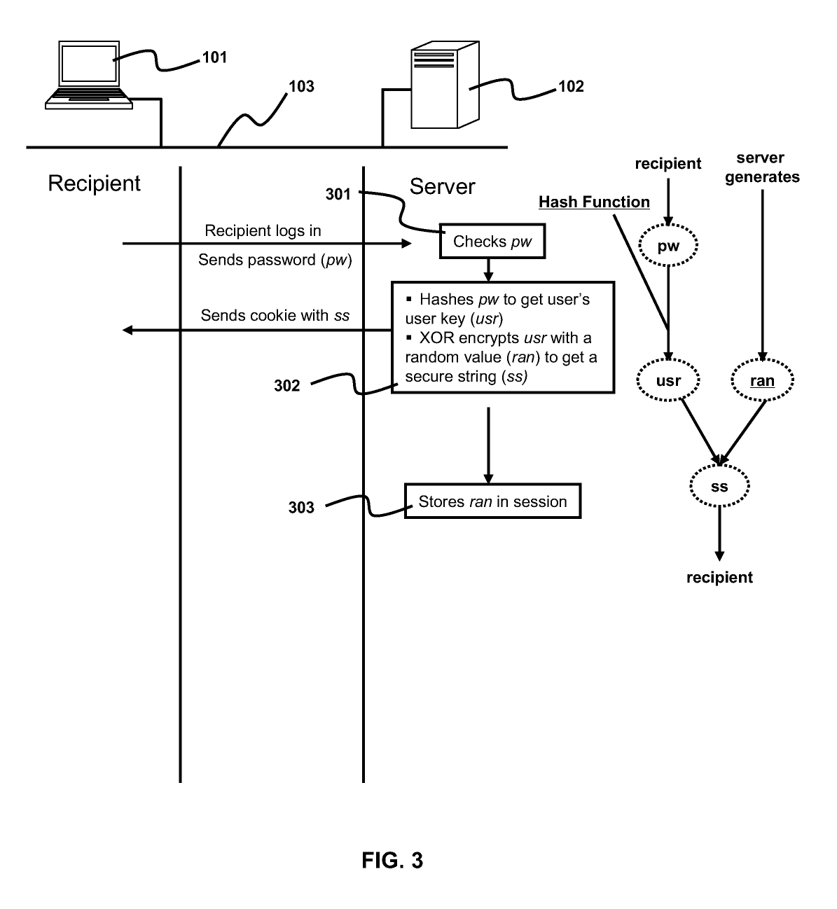

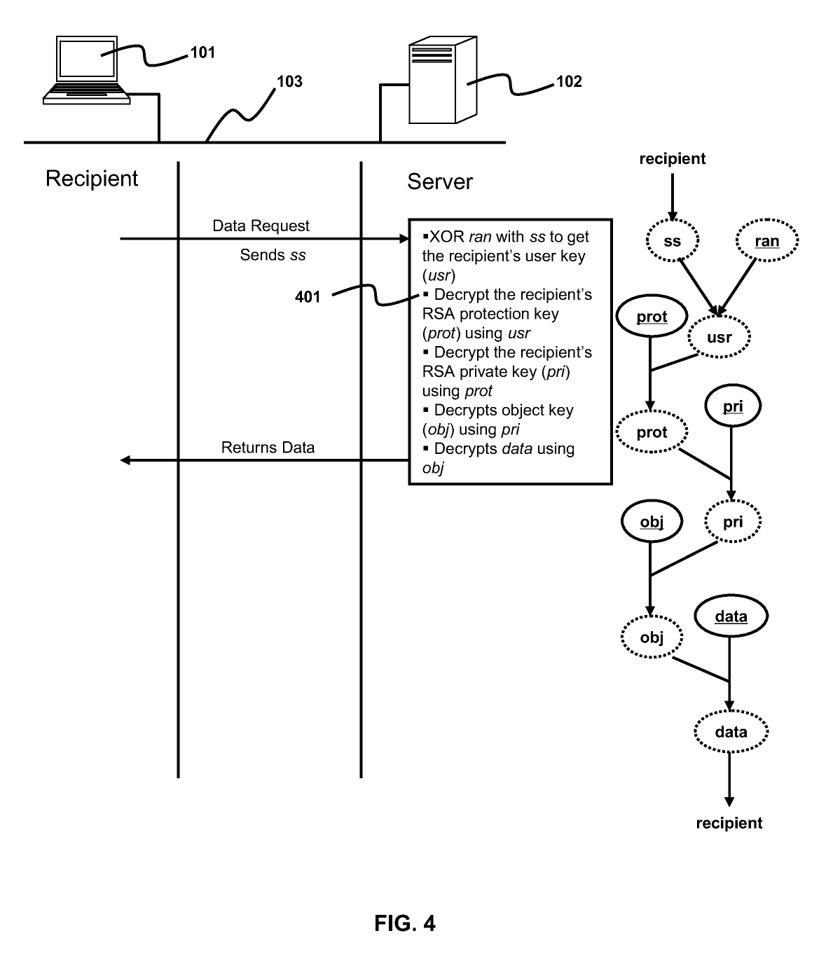

The present disclosure provides methods and systems for secure transmission of a message over a network. In one embodiment, the message is encrypted and stored in an encrypted format before the transmission, as illustrated in FIG. 1. In another embodiment, the message has one or more designated recipients, which can be registered users on a server that stores and transmits the message. In some embodiments, the designated recipients include the sender itself so that the sender can retrieve or view the message as well. Before the server transmits or displays the message to the recipient, e.g., in response to the recipient's request, the encrypted message is decrypted (illustrated in FIG. 3-4). Such decryption, in one embodiment, requires access to certain information (e.g., user identification and password) of the recipient. It is helpful, therefore, to first describe such information of a recipient and the use thereof for data encryption and decryption.

A. User Information Useful for Data Encryption and Decryption

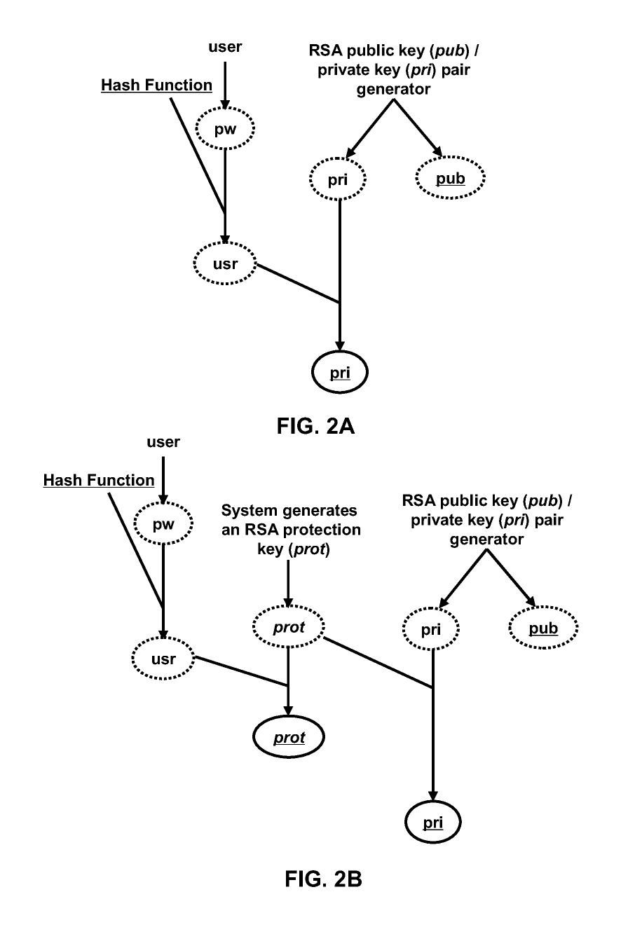

With reference to FIG. 2A-B, a registered user on a server (e.g., a recipient of a message) has an account that includes an account identification (not shown) and a password (pw). In one embodiment, the password (pw) is stored in an encrypted format on the server. In another embodiment, however, the password is not stored on the server, but instead can be authenticated using methods such as a hash function. In this case, the password provided during the login is run through a hash function and compared against the user's exiting hashed password on the server.

As shown in FIG. 2A-B, for each user, a user key (usr) is assigned and can be retrieved for the user upon a successful login. The retrieval, for instance, can be carried out with a hash function taking the user's password (pw) as an input.

In addition to the user key (usr), associated with each user there can be a public (pub)/private (pri) key pair. In one aspect, the public/private key pair is so designed that a message encrypted by the public key (pub) can only be decrypted by the private key (pri). Such public/private key pairs can be generated with methods known in the art and will be discussed in more details below.

As FIG. 2A shows, the private key (pri) of the user can be encrypted with the user key (usr) before the private key (pri) is stored on the server. Alternatively, however, another layer of security can be added by encrypting the private key (pri) with a protection key (prot), which in turn is encrypted with the user key (usr) (FIG. 2B). It is noted that the additional layer of encryption can make rekeying of the user's old data easier. Without this step, forced/forgotten password changes require generating a new public/private key pair, then going through the old object keys for the user and re-encrypting them for the new key pair. With this step, only the protection key needs to be re-generated for the user's new password. It will become clear, in the description of FIG. 4 below, that the decryption of the private key (pri) encrypted by the processes of FIGS. 2A and 2B, respectively, will be different accordingly.

It would be readily appreciated by skilled artisan that, whether the private key (pri) is encrypted by the process of FIGS. 2A or 2B, the private key (pri) is not to be stored on the server in a non-encrypted form. The public key (pub), on the other hand, can be stored without encryption. In some embodiments, “not stored on the server” means that the information is only stored in volatile memory (e.g., RAM or CPU caches) which requires power to maintain the storage.

B. Public/Private Key Pairs

In some embodiments, the public (pub)/private (pri) key pairs of the present disclosure are so designed that a message encrypted with the public key (pub) cannot be decrypted with the public key (pub), without hacking or substantial difficulty, but can be decrypted with the private key (pri). Design of such public/private key pairs can be done with methods known in the art.

An exemplary method of generating such public/private key pairs is known as the RSA algorithm, named after the creators, Ron Rivest, Adi Shamir and Leonard Adleman. In general, the public and private keys for the RSA algorithm are generated the following way:

1. Choose two distinct prime numbers p and q,

2. Compute n=p×q;

3. Compute φ(n)=(p−1)×(q−1), where φ is Euler's totient function;

4. Choose an integer e such that 1<e<φ(n) and the greatest common denominator of (e, φ(n))=1, i.e., e and φ(n) are coprime,

5. Determine d=e⁻¹ mod φ(n); i.e., d is the multiplicative inverse of e mod φ(n) (or, solve for d given (d×e)mod φ(n)=1).

Here, e is the public key exponent and d is used as the private key exponent. e having a short bit-length and small Hamming weight, but greater than 3, results in more efficient encryption. For security purposes, it is preferred that the integers p and q are chosen at random, and are relatively large numbers. Also, n is used as the modulus for both the public and private keys.

Then, the public key is generated consisting of the modulus n and the public (or encryption) exponent e. The private key, meanwhile, consists of the modulus n and the private (or decryption) exponent d.

Variations and improvements of the RSA algorithm are well known in the art, such as the padding scheme, a modification and addition to the RSA algorithm, described by Bellare and Rogaway in 1995.

C. Encryption Process

Referring back to FIG. 1, when encrypting a message (data) received from a sender on client machine 101, through a network 103, the server 102 generates a random object key (obj) that is used to encrypt the message (Step 111). The object key itself is not stored on the server, until after being encrypted. In some aspects, encryption of the object key (obj) uses the public key (pub) (Step 112) associated with the designated recipient of the message (data), such that the message (data) can only be decrypted and retrieved by the designated recipient.

After the encryption, the encrypted message (data) and object key (obj) can be stored on the server (Steps 113 and 114). Deletion of the message (data) and/or object key (obj) can be carried out when the session is over or the message (data) is successfully retrieved by the designated recipient.

As provided, the message so encrypted cannot be decrypted with the public key (pub). Rather, it should be decrypted with the corresponding private key (pri) which is stored on the server in an encrypted form.

D. Decryption Setup

When the designated recipient of a message desires to retrieve the message, the recipient needs to authenticate itself and then use the authentication to decrypt and retrieve the message. FIG. 3 illustrates a decryption setup process that can be used to authenticate the recipient and prepare the recipient for message decryption and retrieval.

As a first step, the recipient logs into the server 102 by sending over login credentials, such as user identification and password (pw), over the network 103, from a client machine 101. The server checks the login credentials (Step 301), and if they are correct, authorizes the login. The correct login credentials can then be used to retrieve the recipient's user key (usr) which is then used to decrypt messages (Step 302). The retrieval, in one aspect, is effected with a hash function that contains the user key (usr).

The system also generates a random value (ran) that can be used to encrypt the user key (usr). In one aspect, the random value (ran) has the same string length as the user key (usr). In one aspect, the random value (ran) and the user key (usr) are combined to form a secure string (ss). The some aspects, the combination entails an XOR cipher.

The term “XOR cipher,” sometimes denoted with the ⊕ symbol, is also known as an “exclusive disjunction operator.” The XOR cipher is an encryption algorithm that operates according to the following principles:

A⊕0=A,

A⊕A=0,

(A⊕B)⊕C=A⊕(B⊕C), and

(B⊕A)⊕A=B⊕0=B.

For instance, when used in encryption/decryption, a string of text can be encrypted by applying the bitwise XOR operator to every character using a given key. To decrypt the output, therefore, merely reapplying the XOR function with the key will remove the cipher.

After the secure string (ss) is generated, the secure string (ss) can be transmitted back to the recipient and saved on the recipient's device, during a session. A non-limiting form of the transmission and storage of secure string (ss) is in a cookie. The random value (ran) can then be stored on the server (Step 303). By contrast, the secure string (ss) is never stored on the server and the user key (usr) is never stored at all. As such, even if the server is compromised, only the random value (ran) is under the risk of being released, which alone, without the secure string, would not enable recovery of the user key (usr), which is required for decrypting a message.

E. Decryption Process

When the designated recipient requests to retrieve a secure message, the request can be sent along with the secure string (ss) that the server has generated for the recipient upon login of the recipient (see FIG. 3). Referring to FIG. 4, the server receives the request and the secure string (ss), and combines the secure string (ss) with the random value (ran), which is stored in the session on the server, to reconstitute the user key (usr).

Once the user key (usr) is reconstituted, the user key (usr) can be used to decrypt the encrypted private key (pri) directly, if the private key (pri) has been encrypted as illustrated in FIG. 2A, or decrypt the protection key (prot) which in turn decrypt the private key (pri), if the private key (pri) has been encrypted as illustrated in FIG. 2B. In either case, the decrypted private key (pri) is then used to decrypt the encrypted object key (obj) which then is able to decrypt the message (data) (Step 401).

The server, upon decryption of the message (data), can then return the message to the recipient, completing the secure message transmission.

F. Encryption/Decryption Keys and Techniques

Methods for encrypting/decrypting messages (e.g., protection key, private key, object key, and data) are known in the art, such as, symmetric key encryption schemes such as DES/3DES, AES, and Blowfish, asymmetric key encryption schemes such as RSA and ElGamal, or block ciphers, stream ciphers, secret key cryptography, public key cryptography, hash functions, without limitation.

G. Computer Network

It will be appreciated by the knowledgeable reader that the methods of the present disclosure can be implemented on any computer network. Methods and devices for providing network data transmission are well known in the art.

Embodiments can include program products comprising non-transitory machine-readable storage media for carrying or having machine-executable instructions or data structures stored thereon. Such machine-readable media may be any available media that may be accessed by a general purpose or special purpose computer or other machine with a processor. By way of example, such machine-readable storage media may comprise RAM, ROM, EPROM, EEPROM, CD-ROM or other optical disk storage, magnetic disk storage or other magnetic storage devices, or any other medium which may be used to store desired program code in the form of machine-executable instructions or data structures and which may be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, logics, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed and cloud computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

It should be noted that although the discussions herein may refer to a specific order and composition of method steps, it is understood that the order of these steps may differ from what is described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

Unless otherwise defined, all technical and scientific terms used herein have the same meaning as commonly understood by one of ordinary skill in the art to which this invention belongs.

The inventions illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed.

Thus, it should be understood that although the present invention has been specifically disclosed by preferred embodiments and optional features, modification, improvement and variation of the inventions embodied therein herein disclosed may be resorted to by those skilled in the art, and that such modifications, improvements and variations are considered to be within the scope of this invention. The materials, methods, and examples provided here are representative of preferred embodiments, are exemplary, and are not intended as limitations on the scope of the invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

In addition, where features or aspects of the invention are described in terms of Markush groups, those skilled in the art will recognize that the invention is also thereby described in terms of any individual member or subgroup of members of the Markush group.

All publications, patent applications, patents, and other references mentioned herein are expressly incorporated by reference in their entirety, to the same extent as if each were incorporated by reference individually. In case of conflict, the present specification, including definitions, will control.

It is to be understood that while the disclosure has been described in conjunction with the above embodiments, that the foregoing description and examples are intended to illustrate and not limit the scope of the disclosure. Other aspects, advantages and modifications within the scope of the disclosure will be apparent to those skilled in the art to which the disclosure pertains.

1. A method for securely transmitting a message to a recipient, comprising:
receiving, at a server, a request from a recipient to retrieve a message,
wherein the message is encrypted with an object key;
wherein the object key is encrypted with a public key from a public/private key pair associated with the recipient, and the private key is encrypted based on a user key associated with the recipient's login credential, the public/private key pair being configured so that information encrypted with the public key can only be decrypted with the private key; and
wherein the request is accompanied by a secure string, the secure string being generated by combining a random string and the user key, wherein the user key is retrieved when the recipient logs in;
decrypting the encrypted message by:
reconstituting the user key with the secure string and the random string;
decrypting the private key of the recipient with the user key;
decrypting the object key with the private key; and
decrypting the message with the object key; and
delivering or displaying the message to the recipient.

2. The method of claim 1, wherein the private key is encrypted with a protection key, which is encrypted with the user key, and the decrypting of the private key comprises decrypting the protection key with the user key and decrypting the private key with the protection key.

3. The method of claim 1, wherein the server does not store one or more of non-encrypted message, non-encrypted object key, non-encrypted private key, non-encrypted user key, or the secure string.

4. The method of claim 1, wherein the login credential of the recipient comprises the password of the recipient.

5. The method of claim 4, wherein the server does not store the password.

6. The method of claim 1, wherein the public/private key pair is an RSA public/private key pair.

7. The method of claim 1, wherein the user key is retrievable with a hash function with the recipient's credential.

8. The method of claim 1, wherein the random string has the same string length as the user key.

9. The method of claim 8, wherein the secure string is generated with an XOR cipher using the random string and the user key as inputs.

10. The method of claim 1, wherein the message is an email message, a text message, an instant message, an voice message, a video message, a news message or an electronic document.

11. The method of claim 1, wherein the request from the recipient is sent from a mobile device.

12. The method of claim 1, wherein the message is sent from a sender from a mobile device.

13. A computing device for securely transmitting a message to a recipient, comprising a memory, a processor and program code which, when executed by the processor, configures the system to:
receive a request from a recipient to retrieve a message,
wherein the message is encrypted with an object key;
wherein the object key is encrypted with a public key from a public/private key pair associated with the recipient, and the private key is encrypted based on a user key associated with the recipient's login credential, the public/private key pair being configured so that information encrypted with the public key can only be decrypted with the private key; and
wherein the request is accompanied by a secure string, the secure string being generated by combining a random string and the user key, wherein the user key is retrieved when the recipient logs in;
decrypt the encrypted message by:
reconstituting the user key with the secure string and the random string;
decrypting the private key of the recipient with the user key;
decrypting the object key with the private key; and
decrypting the message with the object key; and
deliver or display the message to the recipient.

14. The computing device of claim 13, wherein the private key is encrypted with a protection key, which is encrypted with the user key, and the decrypting of the private key comprises decrypting the protection key with the user key and decrypting the private key with the protection key.

15. The computing device of claim 13, wherein the user key is retrievable with a hash function with the recipient's credential.

16. The computing device of claim 13, wherein the secure string is generated with an XOR cipher using the random string and the user key as inputs.

17. A non-transitory computer-readable media for securely transmitting a message to a recipient, comprising program code which, when executed, configures a computing device to:
receive a request from a recipient to retrieve a message,
wherein the message is encrypted with an object key;
wherein the object key is encrypted with a public key from a public/private key pair associated with the recipient, and the private key is encrypted based on a user key associated with the recipient's login credential, the public/private key pair being configured so that information encrypted with the public key can only be decrypted with the private key; and
wherein the request is accompanied by a secure string, the secure string being generated by combining a random string and the user key, wherein the user key is retrieved when the recipient logs in;
decrypt the encrypted message by:
reconstituting the user key with the secure string and the random string;
decrypting the private key of the recipient with the user key;
decrypting the object key with the private key; and
decrypting the message with the object key; and
deliver or display the message to the recipient.

18. The non-transitory computer-readable media of claim 17, wherein the private key is encrypted with a protection key, which is encrypted with the user key, and the decrypting of the private key comprises decrypting the protection key with the user key and decrypting the private key with the protection key.

19. The non-transitory computer-readable media of claim 17, wherein the user key is retrievable with a hash function with the recipient's credential.

20. The non-transitory computer-readable media of claim 17, wherein the secure string is generated with an XOR cipher using the random string and the user key as inputs.
